(19) United States
(12) Patent Application Publication
(10) Pub. No.: US 2008/0291602 A1
(43) Pub. Date: Nov. 27, 2008

(54) STACKED MULTILAYER CAPACITOR

(76) Inventor: Daniel Devoe, San Diego, CA (US)

Correspondence Address: WOOD, HERRON & EVANS, LLP, 2700 CAREW TOWER, 441 VINE STREET, CINCINNATI, OH, 45202, US

(21) Appl. No.: 11/753,090

(22) Filed: May 24, 2007

(51) Int. Cl. H01G 4/232; B23P 19/00

(52) U.S. Cl. 361/306.3; 29/739

(57) ABSTRACT

A capacitor device, which is mountable on a substrate, has an electrically conductive bottom lead frame with a bottom plate mountable substantially parallel to, and in contact with, the substrate and an electrically conductive top lead frame having a top plate spaced apart from the bottom plate and a first transition portion having a first end connected to the top plate and a second end, opposite the first end, electrically connectable to the substrate. Multilayer capacitors are mounted between the top plate and the bottom plate. The capacitors have opposed end terminations electrically connected to the top and bottom plates, such that internal electrode plates are substantially nonparallel to the substrate.

### FIELD

The present invention relates generally to stacked ceramic capacitors and more specifically, to mounting a stacked ceramic capacitor to a substrate.

### BACKGROUND

Multilayer ceramic chips are common capacitors used for bypass, coupling, or energy storage applications in electronic circuits. Common sizes of the chips may range from 0201 (0.02″×0.01″) to 1206 (0.12″×0.06″). Larger sized chips may give higher capacitance at any given voltage rating. In some cases, there may be a need for much larger multilayer ceramic capacitors, ranging in size from 0.25″×0.25″, up to 1.2″×1.2″ in area. Usually in these larger sizes, it is desirable to use multiple chips together. These chips 22 are often stacked one on top of another as illustrated in FIGS. 1A and 2A, then soldered 28 together with leads or are soldered to a lead frame 26. With this technique, it is possible to make large capacitance values (1 μF to 180 μF) at moderate voltages (50 V to 500V).

Stacked capacitors 20 may be used in different power supply designs including: (1) resonant power supplies, operating at 1 MHz to 60 MHz, with a high power AC sine wave applied to the capacitors; (2) direct filtering across three phases of an AC supply operating at low frequency (60-800 Hz) at moderate voltages (48-480 volts); and (3) DC-DC converters, on the input or output side of the supply, where the capacitors see a moderate DC voltage plus an AC ripple that comes off of a switching transistor (at 100 k kHz to 500 kHz and 0.1 to 3 amps current). The stacked capacitors may carry high power due to high ripple current from switching transistors.

Circuit designers who use stacked capacitors 20 for these applications are concerned first with the capacitance and voltage rating that will make the circuit function. There is also a concern with second order effects such as the effects of heat dissipation affecting thermal expansion or contraction and vibration from mechanical shock. Heat dissipation is primarily achieved by conduction. It is generally accepted that air convection accounts for only a small portion of the heat dissipated from the chip 22. Conduction occurs through an internal electrode to the silver end terminations 24 through the solder 28 to the lead frames 26 and then into a circuit board 30 or other substrate. In the case of the stacked capacitor 20, the heat conduction has a longer path due to the height of the stack. Heat conduction from the top of the stack down to the circuit board 30 may be very inefficient.

Generally speaking, since a great deal of heat is generated in the vicinity of a source, substrates are normally constituted of an aluminum having a high heat discharge capacity. However, since the temperature in the vicinity of the source changes greatly when the source is turned on and off, a significant amount of thermal stress occurs at a ceramic capacitor mounted on the aluminum substrate, which has a high coefficient of thermal expansion. This thermal stress may cause cracking to occur at the ceramic capacitor, which, in turn, may induce problems such as shorting defects and arcing.

Further concerns about the performance of stacked capacitors arise under vibration and mechanical shock conditions. The stacks may be tall and heavy. Under normal design conditions, the height may reach 0.72 inches in some stacked configurations, with areas ranging from 0.25″×0.25″ up to 1.2″×2.0″. When used in a satellite or rocket, there is a legitimate concern of the part falling off of the circuit board, or at least of the solder joints cracking or breaking loose resulting from excessive vibrations and extreme environmental conditions. Many designers resort to using an epoxy to help adhere the capacitor to the board, but this is not optimal because the epoxy itself might cause problems, such as thermal stresses, under certain temperature conditions due to the expansion or contraction of the epoxy.

An additional concern is that the inductance of the capacitors in a power application may have a large impact on the performance of the chip. Lower inductance is always a good property in a ceramic capacitor. One common method of achieving lower inductance is to rotate the aspect ratio of the chip as can be seen in FIG. 2B. A traditional 1206 chip 22 (0.12″×0.06″), FIG. 2A, can have half the inductance if the dimensions of the chip 22 are changed to 0612 (0.06″×0.12″) as shown on chip 42, FIG. 2B. Literature claims that the change from 1206 to 0612 will reduce the inductance from 1200 pH to 170 pH.

What is needed in the art, therefore, is a stacked multilayer capacitor that does not have the disadvantages described above.

### SUMMARY

The present invention provides a stacked multilayer capacitor that substantially improves heat transfer from the capacitor, is tolerant of thermal stresses caused by expansion and contraction, is resistant to vibration and mechanical shock conditions and has a low inductance. The stacked multilayer capacitor has a split lead frame that provides larger areas in electrical contact with the capacitor and a substrate to substantially improve heat transfer from the capacitor and provide an improved tolerance to thermal stresses resulting from expansion and contraction. Further, the split lead frame may optionally be used to attach the stacked multilayer capacitor to the substrate with fasteners, thereby making it more tolerant to vibration and mechanical shock. In addition, the split lead frame facilitates mounting the stacked multilayer capacitor on the substrate in an orientation that reduces inductance.

In one embodiment, the stacked multilayer capacitor has a split lead frame with an electrically conductive bottom lead frame having a bottom plate adapted to be mounted substantially parallel to, and in contact with, a substrate. An electrically conductive top lead frame has a top plate spaced apart from the bottom plate, and a first transition portion having a first end connected to the top plate and a second end, opposite the first end, adapted to be electrically connected to the substrate. Multilayer capacitors are mounted between the top plate and the bottom plate. The multilayer capacitors have respective first end terminations, which are electrically connected to the bottom plate, and respective second end terminations, which are electrically connected to the top plate. The multilayer capacitors have first electrode plates electrically connected to the respective first end terminations and second electrode plates electrically connected to the respective second end termination. The multilayer capacitors are mounted between the top plate and bottom plate such that the first electrode plates and the second electrode plates are substantially nonparallel to the substrate.

In other embodiments of the split lead frame, the bottom lead frame has a corrugated shape. The corrugated shape of the bottom lead frame may provide compliance between the first multilayer capacitor and the substrate to potentially reduce problems with thermal expansion causing thermal stresses.

In some embodiments of the split lead frame in the invention, the top lead frame has a first flange portion in electrical connection with the substrate. The first flange portion is electrically connected to the second end of the first transition portion of the top lead frame. In some embodiments, the flange portion is soldered to the substrate, while in others the flange portion is mechanically and electrically connected to the substrate using a fastener such as a screw or a rivet.

In other embodiments of the top lead frame, a second transition portion may be added. The second transition portion also has a first end connected to the top plate and a second end, opposite the first end, adapted to be electrically connected to the substrate. Some embodiments of this top lead frame also include a second flange portion, which is in electrical connection with the substrate, and is electrically connected to the second end of the second transition portion of the top lead frame. Other embodiments of the top lead frame may contain a third transition portion with a third flange portion. Embodiments of the top lead frame may also be configured without flange portions. Some of these embodiments may contain a plurality of finger type connectors. The finger type connectors are electrically connected to the transition portions of the top lead frame and are mounted to the substrate though mounting holes in the substrate.

### BRIEF DESCRIPTION OF THE DRAWINGS

The accompanying drawings, which are incorporated in and constitute a part of this specification, illustrate embodiments of the invention and, together with a general description of the invention given above, and the detailed description given below, serve to explain the principles of the invention.

FIG. 1A illustrates a known configuration for a stacked multilayer capacitor.

FIG. 1B illustrates a known configuration for a beam lead capacitor.

FIG. 2A illustrates a stack of known multilayer capacitors.

FIG. 2B illustrates the stack of multilayer capacitors in FIG. 2A with rotated aspect ratios.

FIG. 3 illustrates the internal electrodes of an exemplary known multilayer capacitor.

FIG. 4 illustrates a front view of a stacked multilayer capacitor consistent with an exemplary embodiment of the invention.

FIG. 5 is an exploded view of the components of the stacked multilayer capacitor in FIG. 4.

FIG. 6 is an exploded view of an alternate embodiment of the stacked multilayer capacitor shown in FIG. 4.

FIG. 7 is a top view of the stacked multilayer capacitor shown in FIG. 4.

FIG. 8 illustrates a perspective view of a stacked multilayer capacitor consistent with another exemplary embodiment of the invention.

FIG. 9 is a top view of the stacked multilayer capacitor shown in FIG. 8.

FIG. 10 illustrates an exploded, perspective view of a stacked multilayer capacitor consistent with another exemplary embodiment of the invention.

FIG. 11 is a top view of the stacked multilayer capacitor shown in FIG. 10.

FIG. 12A illustrates an exploded, perspective view of a stacked multilayer capacitor consistent with another exemplary embodiment of the invention.

FIG. 12B is an alternate configuration of the stacked multilayer capacitor of FIG. 12A.

FIG. 13A illustrates an alternate exemplary embodiment of the stacked multi-layer capacitor shown in FIG. 6.

FIGS. 13B-13D illustrate alternate mounting configurations of the stacked multilayer capacitor of FIG. 13A.

FIG. 14 is a perspective view of a configuration of the top lead frame shown in FIGS. 13A-13D.

FIG. 15A is a top, flattened view of the top lead frame shown in FIG. 13D.

FIG. 15B is a top, flattened view of the top lead frame shown in FIG. 13A-13C.

FIG. 16 illustrates an alternate exemplary embodiment of a bottom lead frame of the stacked multi-layer capacitor shown in FIG. 6.

FIG. 17 is a perspective view of the bottom lead frame shown in FIG. 15.

FIG. 18 illustrates an alternate exemplary embodiment of the stacked multilayer capacitor shown in FIG. 4 without the bottom lead frame.

FIG. 19 illustrates a front view of an alternate embodiment of the capacitors of the stacked multilayer capacitor in FIG. 4.

FIG. 20 is a perspective view of the stacked multilayer capacitor of FIG. 6 mounted on a circuit board.

FIG. 21 is a cross section of the stacked multilayer capacitor shown in FIG. 20 generally along line 21-21.

FIG. 22 is a cross section of the stacked multilayer capacitor shown in FIG. 21 generally along line 22-22.

### DETAILED DESCRIPTION

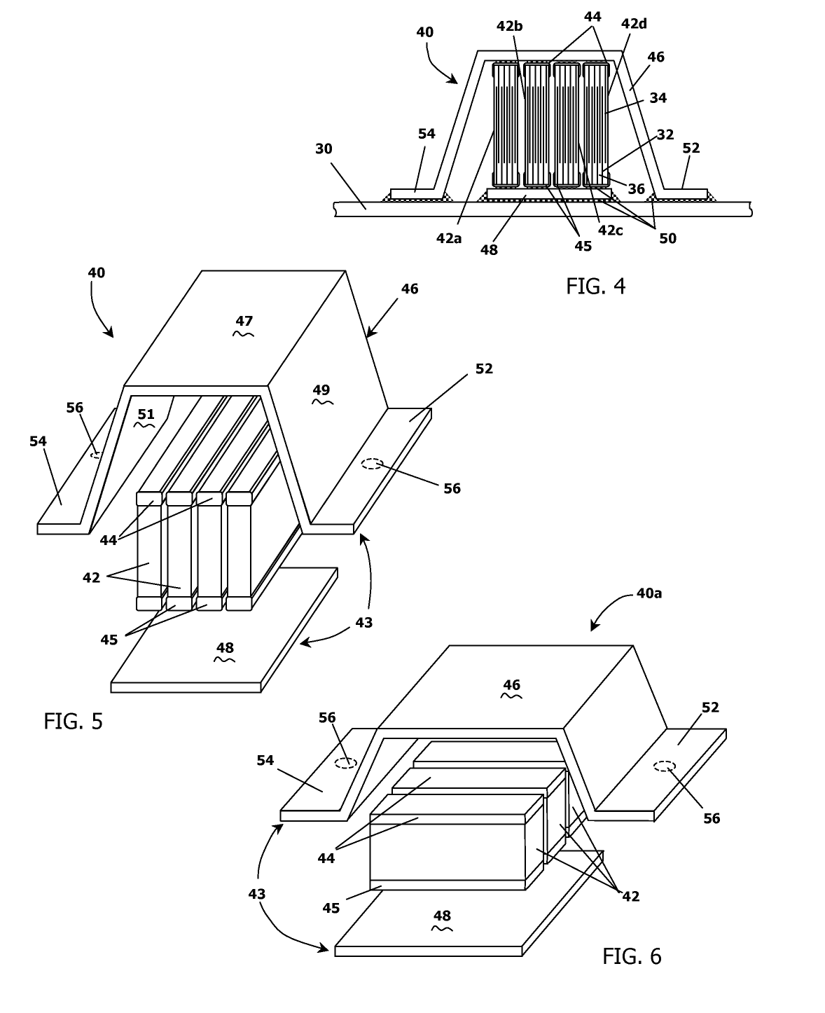

The present invention addresses the problems in the prior art by providing a stacked multilayer capacitor with improved vibration, inductance and thermal characteristics. The multilayer capacitors may be of the type illustrated in FIG. 3. Referring to FIG. 3, the multilayer capacitor 42 may consist of a ceramic body 36, or the body may be composed of some other dielectric material. Internal electrode plates 32, 34 are positioned and alternated in the ceramic body 36 forming capacitors therein. End terminations 44, 45 electrically connect each of the respective internal electrode plates 32, 34 and provide an external electrical connection to the multilayer capacitor.

Turning now to the remaining drawings, wherein like numbers denote like parts throughout the several views, FIGS. 4 and 5 illustrate an exemplary embodiment of the stacked multilayer capacitor. The stacked multilayer capacitor 40 is composed of a split lead frame 43 having a bottom lead frame 48 containing a bottom plate and a top lead frame 46. The lead frame 43 electrically connects one or more multilayer capacitors 42a-42d having respective conductive end terminations 44, 45. The multilayer capacitor may be a capacitor 42 known in the art and discussed above (FIG. 3). As discussed above, the aspect ratios of the multilayer capacitors may be rotated to achieve a lower inductance in each of the multilayer capacitors 42a-42d in the stack. For embodiments of the capacitor where vibration rather than inductance or heat reduction is the design variable, then the length of the capacitors from termination to termination may be equal to the width of the capacitor, or the length from termination to termination may be longer than the width of the capacitor. For example, a chip size of 0.4″×0.4″ in area and 0.125″ thick, with about four chips standing on end may make up the stacked capacitor.

The split lead frame 43 may be composed of materials made out of various types of conductive material, for example, copper, alloy 42, kovar or other conductive metals or materials. Any combination of alloy may be chosen for optimal properties when looking at thermal conductivity, electrical conductivity, and the coefficient of thermal expansion. The materials for the top 46 and bottom 48 lead frames may be different. For example, copper may be chosen for the top lead frame 46 for electrical conductivity but alloy 42 may be chosen for the bottom lead frame 48, because it has reasonable conductivity but very low thermal expansion which may help match the expansion between a circuit board 30 or other substrate and the stacked multilayer capacitor 40. In some of the embodiments solder is used to connect the parts of the stacked multilayer capacitor 40 as well as to connect the capacitor 40 to the circuit board 30. The solder may be a high temperature solder such as 10Sn/88Pb/2Ag. Alternately, some other solder or a conductive epoxy could be used. For example, if the top lead frame is composed of silver and the termination on the capacitor is also composed of silver, the top lead frame may then be joined to the termination with a silver paste that may contain silver powder and glass frit.

FIG. 5 shows an exploded view of the components of the multilayer capacitor 40. The bottom lead frame 48 is electrically connected to the end terminations 45 of a plurality of multilayer capacitors 42. By orienting the multilayer capacitors substantially in the vertical direction, and making the capacitors short in vertical height, the stack is of inherently low inductance and presents a lower profile against the circuit board. The top plate 47 of the top lead frame 46 is designed to electrically contact the terminations 44 on the opposite ends of the multilayered capacitors 42. The opposed edges of the top plate 47 connect to transition portions 49, 51, which extend down toward the circuit board and connect to respective flange portions 52, 54 of the top lead frame 46. This orientation of the stacked multilayer capacitor 40 may result in better electrical performance.

As best seen in FIG. 4, the multilayer capacitors 42 may be positioned such that the interior electrodes 32, 34 are oriented substantially nonparallel with the circuit board 30. Embodiments of the stacked capacitor 40 having multilayer capacitors 42a-42d with interior electrodes 32, 34 oriented substantially normal to the circuit board 30 may provide a smaller footprint on the circuit board 30. Solder areas 50 electrically connect the plurality of multilayer capacitors 42 through the end terminations 44, 45 to the top lead frame 46 and the bottom lead frame 48 respectively. The top 46 and bottom 48 lead frames may also be soldered 50 to a circuit board 30 to provide electrical connections between the circuit board 30 and the stacked capacitor 40.

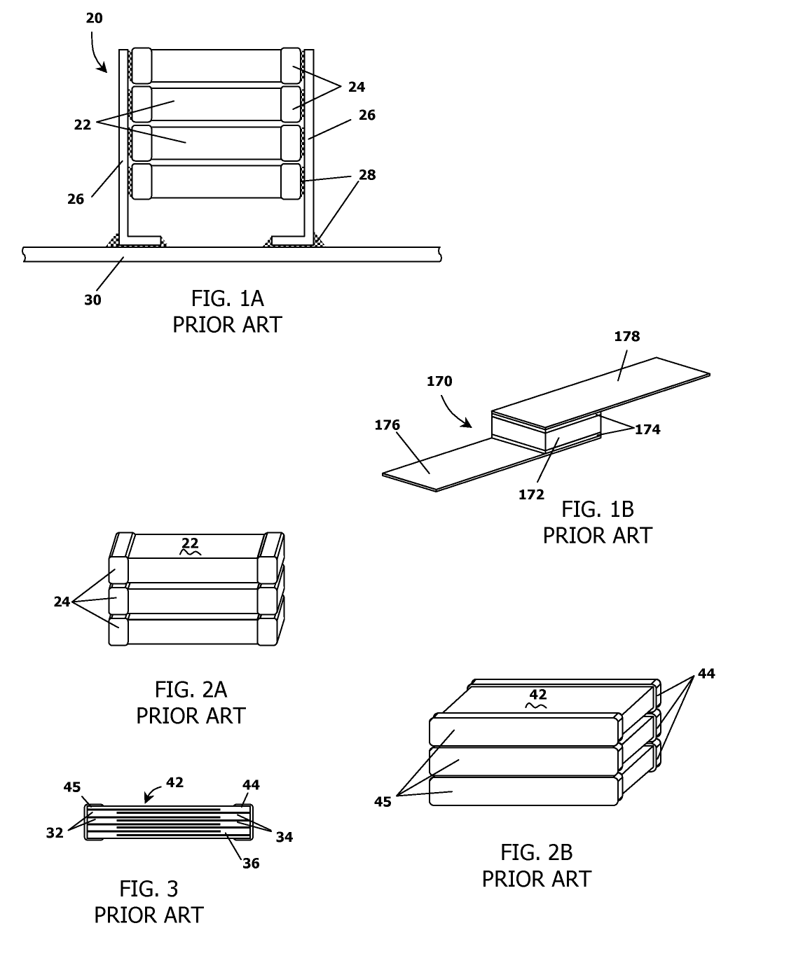

The relative size of the solder areas 50 at the bottom lead frame 48 and flange portions 52, 54 of the top lead frame 46 may be considerably larger than those of the traditional lead frame 26 contacts of a stacked configuration 20 known in the prior art and seen in FIG. 1. Even more importantly, the end terminations 44, 45 in the embodiment shown in FIGS. 4 and 5 are directly in contact with the circuit board through a single base plate of conductive material making up the bottom lead frame 48. This increased contact area directly in contact with the board 30 may allow for better heat transfer characteristics between the stacked multilayer capacitor 40 and the circuit board 30. Typically, the circuit board 30 in a power supply may contain a thick ground plane that may give high conductivity both electrically and thermally. The top lead frame 46 may also assist in transferring heat away from the top of the capacitors 42. Having conductive material connecting from the top of the capacitors 42 down to the circuit board 30 on both sides of the capacitors 42, as seen in FIG. 4, provides heat dissipation from the top of the stacked capacitor 40 that is at least as good as a traditional stack capacitor 20 (FIG. 1). However, due to the increased conductive material making up the top lead frame 46, this configuration may be better at dissipating heat energy.

The top lead frame 46 may also function to hold down the stacked multilayer capacitor 40 overcoming problems due to vibration from mechanical shock. For existing stack capacitors 20, as seen in the prior art in FIG. 1, the mass of the stack is substantial with its center of gravity well above the board, creating a concern that the capacitor may break loose during operation. Previous solutions included using an epoxy to better adhere the stacks to the board. Epoxies may be problematic, however, because many epoxy-based materials have a high co-efficient for thermal expansion. If the epoxy is placed under the stack in a manner that would best hold it down to the circuit board, the epoxy may expand upon normal heating and push the stack off the board, like a jack under a car. Another method applies the epoxy on the side so that it touches the stacked capacitor, but does not flow under. In this case, the co-efficient of thermal expansion may still cause problems, and it is doubtful that the strength of the epoxy on the side will be sufficient to hold the capacitor down.

In the embodiment shown in FIG. 4 the top lead frame 46 not only provides an electrical connection, but also may hold down the capacitor mechanically. The top lead frame 46 may be soldered 50 to the circuit board 30, soldering both flanges 52, 53. In another exemplary embodiment shown in FIG. 5, a hole 56 may be placed on the flange portions 52, 54 of the top lead frame 46 to allow for a fastener (not shown), such as a screw, a rivet, or other comparable fastener, to be used to mechanically connect the top lead frame 46 to the circuit board 30.

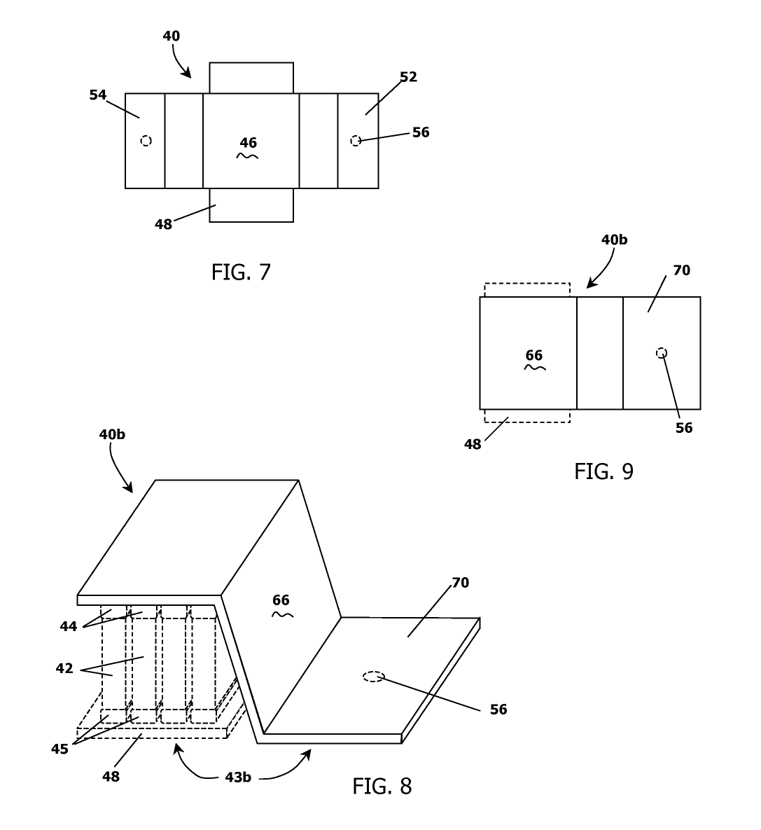

Optional holes 56 may be seen in an alternate embodiment of the stacked multilayered capacitor 40a in FIG. 6. In addition to the holes 56 in this particular embodiment, the plurality of capacitors 42 may be oriented such that their lengths are substantially perpendicular to a length of the flanges 52, 54 of the top lead frame 46. Orienting the plurality of capacitors 42 in such a fashion may lead to improved performance. Orienting the capacitors 42 as shown on the stacked capacitor 40 in FIG. 5 may not realize the performance improvements of the stacked capacitor 40b in FIG. 6, but may allow for better inspection after manufacturing operations because it is possible to look between the capacitors 42 in the stacked capacitor 40. FIG. 7 shows a top view of the embodiments in either FIG. 5 or FIG. 6.

In other embodiments of a split lead frame for a stacked multilayer capacitor, the top lead frame may have alternate configurations. For example, in an exemplary embodiment of a split lead frame 43b shown in FIGS. 8 and 9, the top lead frame 66 used in the stacked multilayer capacitor 40b may contain only one flange portion 70. The top lead frame 66 contacts the end terminations 44 of the multilayer capacitors 42 in the same manner as described in the previous embodiment, and shown in FIGS. 5 and 6. The top lead frame 66 may also have an optional hole 56 as previously discussed above. An advantage of using an embodiment such as the stacked capacitor 60 in FIGS. 8 and 9 would be a smaller footprint on the circuit board 30 which is provided by the top lead frame 66 having only one flange portion 70. The split lead frame 43b consisting of top lead frame 66 and bottom lead frame 48 may be soldered to the circuit board as discussed above, or the top lead frame 66 may also be mechanically connected to the circuit board 30 by a fastener through the optional hole 56 as discussed above. The orientation of the capacitors 42 in the stacked configuration 40b may also be oriented parallel to or normal to a length of the flange portion 70 of the top lead frame 66.

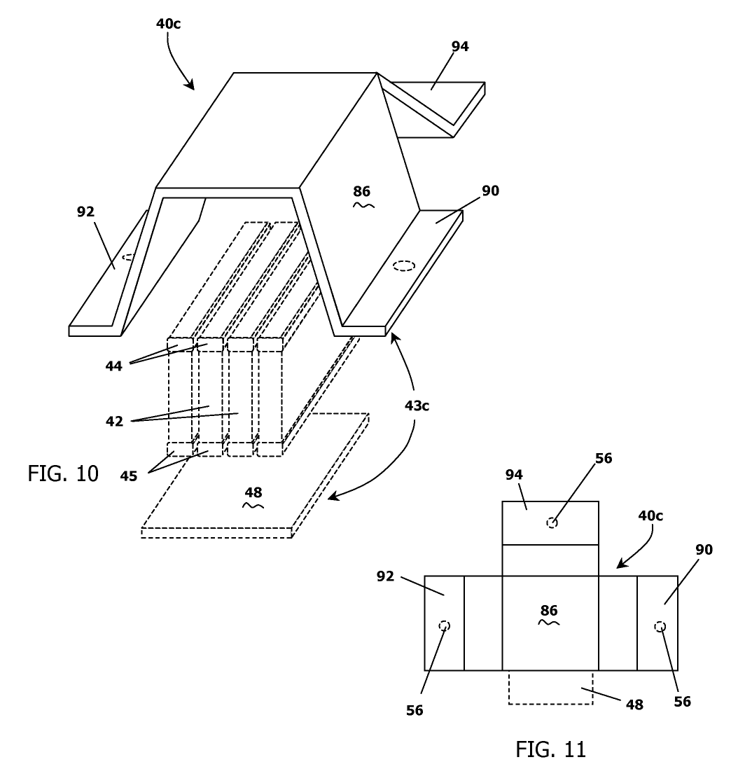

As shown in FIGS. 10 and 11, and in still another embodiment, a split lead frame 43c for a stacked multilayer capacitor has a third flange portion 94 extending from the top lead frame 86. The third flange portion 94 may increase thermal dissipation of the capacitor as well as provide additional electrical and mechanical connections. In the stacked multilayer capacitor configuration 40c, the three flange portions 90, 92, 94 may be soldered to a circuit board, or may contain optional holes 56 through which the top lead frame 86 may be fastened to the circuit board. Similar to the other embodiments, the orientation of the multilayer capacitors 42 may be substantially parallel to, or substantially normal to, the open end of the top lead frame 86. End terminations 44, 45 may be connected directly to the respective top and bottom lead frames 86, 48 by the use of solder. Because this particular embodiment has three flange portions 90, 92, 94, a combination of fasteners and solder inside may be utilized to electrically or mechanically connect this particular embodiment to a circuit board in a manner similar to that described with respect to FIG. 6.

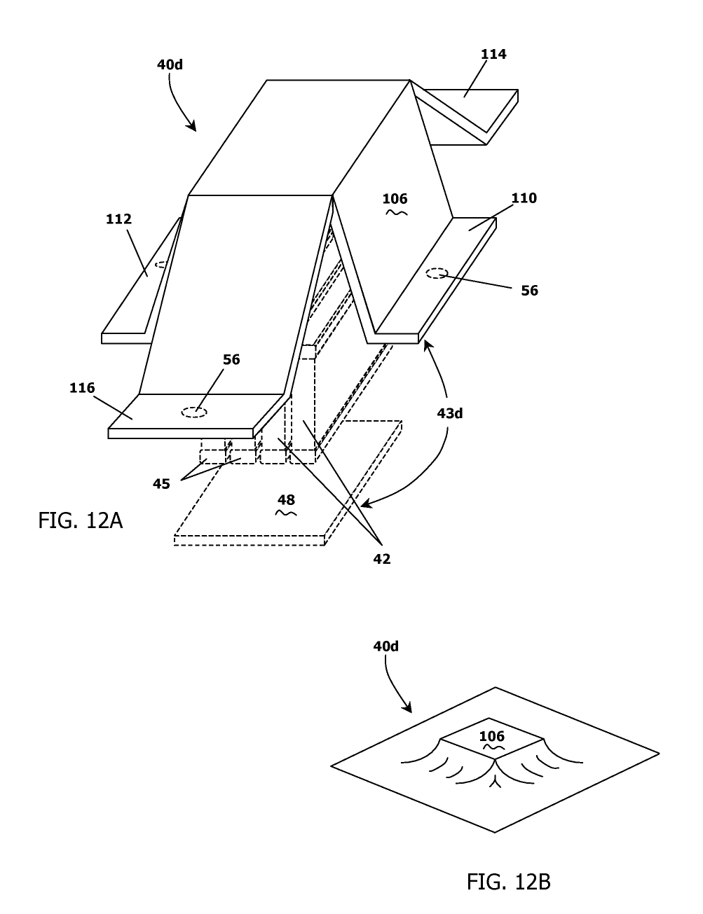

Another exemplary embodiment of the split lead frame 43d is shown in FIG. 12A. In this embodiment, a fourth flange portion 116 extends from the top lead frame 106. Similar to the embodiment above and shown in FIGS. 10 and 11, the additional flange portion 116 may increase thermal dissipation of the capacitor as well as provide additional electrical and mechanical connections. All four flange portions 110, 112, 114, 116 may be soldered to a circuit board or may contain optional holes 56 through which the top lead frame 106 may be fastened to the circuit board. Alternately the top lead frame 106 in this embodiment may be drawn as a single piece as shown in FIG. 12B, rather than the cut and bent configuration shown in FIG. 12A. With this configuration, the corners of the chips would not be exposed, which may make inspection difficult, but may be useful for shielding. An advantage of either configuration in FIGS. 12A and 12B provides for shielding. Shielding may become important for higher operating frequencies, such as in the range of 13 MHz and above.

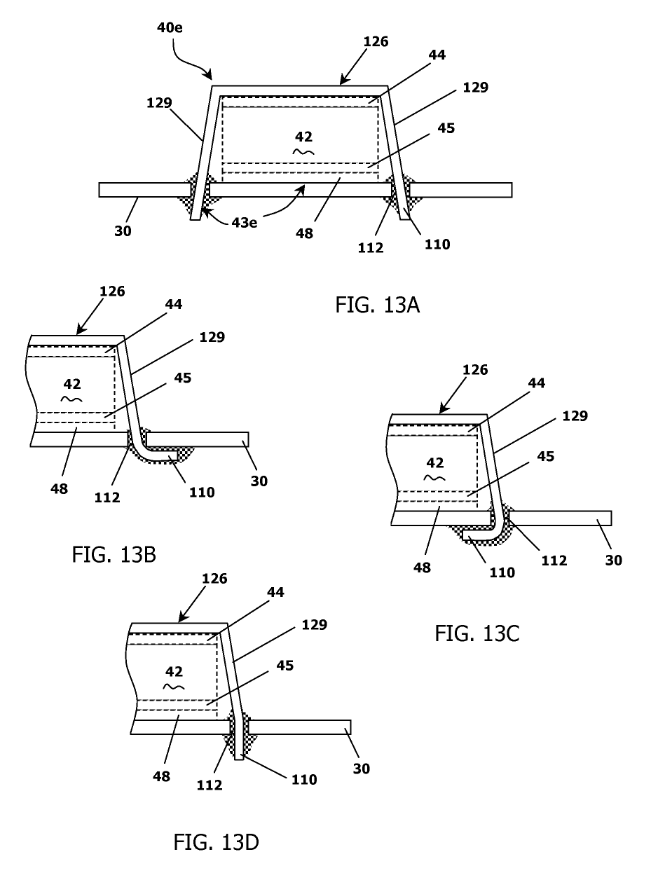

In another exemplary embodiment, a split lead frame 43e shown in FIGS. 13A through 13D has an alternate embodiment of the top lead frame 126. In this embodiment, the top lead frame 126 connects to the circuit board 30 and potentially buried traces (not shown) with a through hole 112 connection. The top lead frame 126 may be a ribbon type configuration where the ends 110 of the ribbon extend through the holes 112 in the circuit board 30. The ends 110 of the top lead frame 126 may then be soldered directly or bent and soldered to the circuit board as shown in the different attachment configurations in FIGS. 13A-13D.

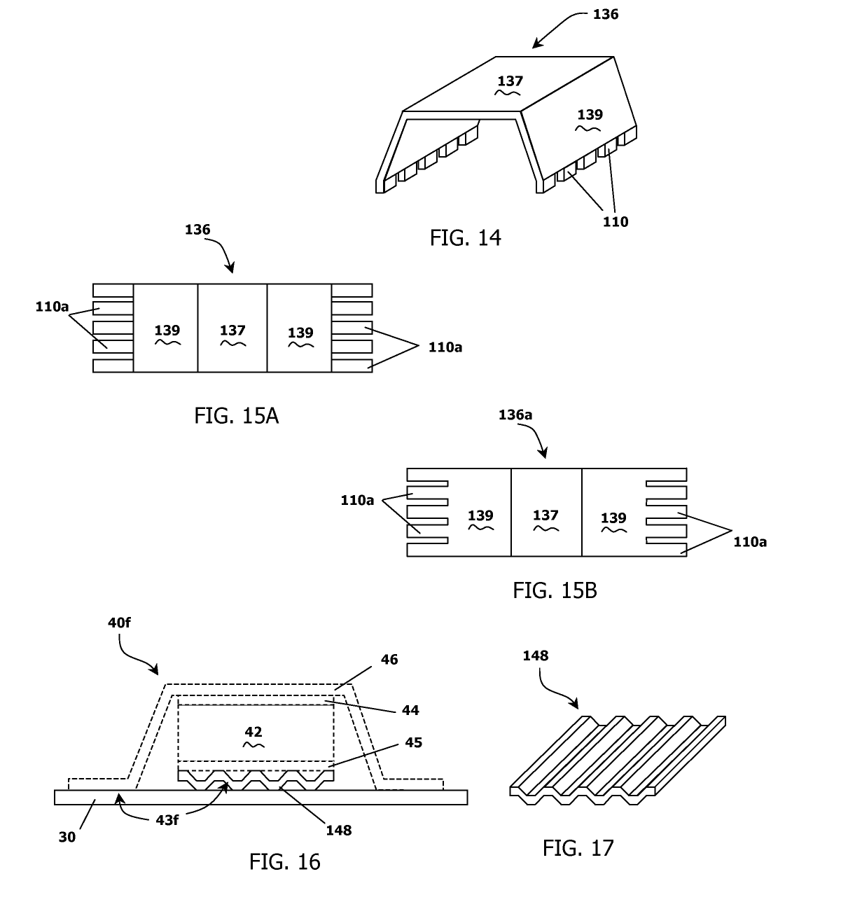

Alternately, the ends 110 may be finger type connectors 110a as shown in FIGS. 14, 15A and 15B. The fingers 110a are connected to a transition portion 139, which electrically connects the fingers 110a to the end terminations 44 of the multilayer capacitors 42 through the top plate 137 of the top lead frame 136. The fingers 110a may be inserted and soldered in holes 112 in the circuit board 30. As with the ribbon type configuration in the top lead frame 126 above, the fingers may be soldered directly or bent and soldered as shown in the FIGS. 13A-13D above.

These embodiments of the top lead frame 126, 136 may have an advantage over the previous embodiments as the additional area devoted to connecting the top lead frames 126, 136 to the circuit board 30 is negligible when compared to connecting the flange portions 52, 54 of the top lead frame 46 (FIG. 4) to solder pads on the circuit board 30 for the embodiments discussed above. Thus, these embodiments have a smaller overall footprint when compared with further examples of the split lead frames 43, 43b, 43c, 43d of the embodiments discussed above, which utilize connecting flanges.

FIGS. 16 and 17 illustrate a stacked multi-layer capacitor 40f with a split lead frame 43f having an alternate embodiment of the bottom lead frame 148. In this embodiment, the bottom lead frame 148 may have a corrugated shape designed to provide compliance between the multi-layer capacitor 42 and the circuit board 30. The compliance may be useful in overcoming issues with thermal stress as the coefficient of thermal expansion of the multilayer capacitor 42 and the circuit board 30 may be different. As with the previous embodiments, the bottom lead frame 148 electrically connects to the circuit board 30 and an end termination 45 of the capacitors 42. The top lead frame 46 provides electrical connections to the opposing end terminations 44 and electrically connects to the circuit board 30 in a manner similar to that described with respect to FIG. 6. Any of the alternate embodiments of the top lead frame discussed above may be used with the corrugated bottom lead frame 148 shown in FIG. 17.

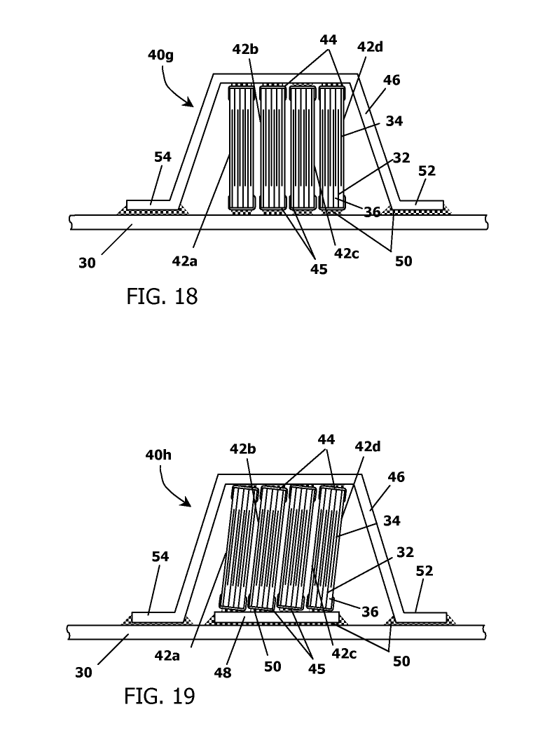

In some embodiments and as best seen in FIG. 18, the bottom lead frame may be omitted and the individual capacitors 42a, 42b, 42c, and 42d may be electrically connected directly to the circuit board 30. End terminations 44 may be attached to the top lead frame 46 as discussed above. The opposite end terminations 45 may be connected directly to a conductive pad on the circuit board by solder, conductive paste, conductive epoxy, or some other attachment.

An alternate embodiment of the multilayer capacitor 40h may be seen in FIG. 19. In this embodiment, the capacitors 42a-42d may be oriented at oblique angles. Orienting the capacitors 42a-42d in such a fashion may still provide the benefits of capacitors that have a more substantial vertical orientation and allow for an altered footprint of the stacked capacitor. This orientation of the capacitors 42a-42d oriented at oblique angles may be used with any of the embodiments of the stacked multilayer capacitors 40-40g discussed above.

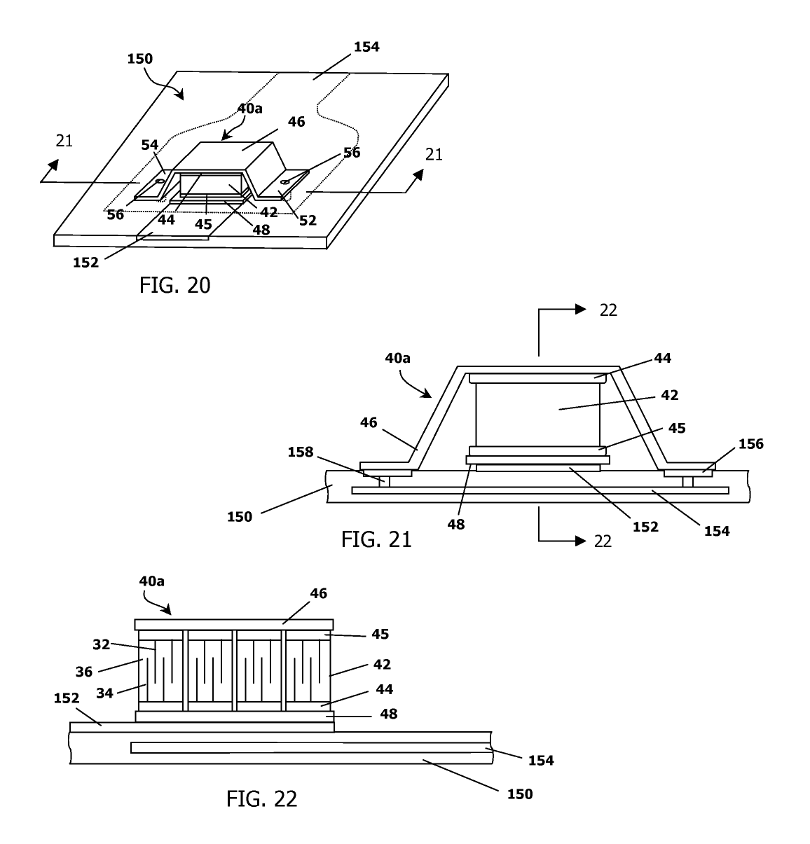

Referring now to FIGS. 20 through 22, an embodiment of the stacked multilayer capacitor 40a (FIG. 6) may be mounted to a printed circuit board 150. The top lead frame 46 may contact and be soldered to one or more solder pads 156 which are electrically connected through respective vias 158 to a buried trace 154. The bottom lead frame 48 may be soldered directly to a surface trace 152. In this particular example, one conducting trace 152 is on top of the board 150; and the other conducting trace 154 is inside of the board 150. Connecting the top lead frame 46 to the solder pads 156 that are connected through vias 158 to the buried trace 154 may provide an advantage of a lower inductance than with other possible board layouts.

Though the stacked multilayer capacitors 40-40h have been illustrated utilizing different split lead frames 43-43f and a plurality of chips or multilayer capacitors 42a-42d (FIG. 4), the device may also be useful with just one multilayer capacitor 42a. The single chip or one multilayer capacitor embodiment would have the same heat dissipation advantages, lower inductance and mechanical stability of the multi-chip embodiments. This single chip embodiment differs from a known capacitor configuration known as a beam lead capacitor. The beam lead capacitor (FIG. 1B) is typically composed of a single layer parallel plate capacitor 170 with the parallel plates 174 parallel to the circuit board. Two silver foil leads 176, 178 electrically connect the capacitor to the circuit board. The bottom lead is traditionally soldered to the circuit board and the top lead solders down to a different location on the board. The width of the top “beam” lead 178 may be the same width as a conductor on the circuit board. Because the beam lead arrangement does not contain interior plates, it does not benefit from the advantages of the multilayer capacitors used in the embodiments described above, including the single chip embodiment.

Additionally, with the multiple chip embodiments, the equivalent series resistance of the stack would be generally lower than traditional designs. For example, a traditional design may have two chips of a 0.4″×0.4″ cross section, but the equivalent design in an embodiment described above may have four vertical chips juxtaposed having cross section of 0.2″×0.4″. The new design has twice as many electroplates which provide the same amount of capacitance (because the plates are half the size, there will be twice as many, hence four chips versus two). Twice as many electrodes gives a lower equivalent series resistance, which may help with the performance of the overall stack.

While the present invention has been illustrated by a description of various embodiments and while these embodiments have been described in considerable detail, it is not the intention of the applicants to restrict or in any way limit the scope of the appended claims to such detail. Additional advantages and modifications will readily appear to those skilled in the art. The invention in its broader aspects is therefore not limited to the specific details, representative apparatus and method, and illustrative examples shown and described. Accordingly, departures may be made from such details without departing from the spirit or scope of applicants' general inventive concept.

What is claimed is:

1. A capacitor device mountable on a plane of a substrate comprising:
an electrically conductive bottom plate adapted to be mounted substantially parallel to, and in electrical contact at the plane of the substrate;
a first multilayer capacitor comprising substantially parallel first and second electrode plates oriented substantially perpendicular to the bottom plate with the first electrode plates being electrically connected to the bottom plate; and
an electrically conductive top lead frame overlapping with, and electrically isolated from, the bottom plate, the top lead frame electrically connected to the second electrode plates and adapted to be electrically connected at the plane of the substrate.

2. The capacitor device of claim 1 further comprising:
a second multilayer capacitor juxtaposed to the first multilayer capacitor,
the second multilayer capacitor comprising substantially parallel first and second electrode plates oriented substantially perpendicular to the bottom plate with the first electrode plates being electrically connected to the bottom plate and the second electrode plates electrically connected to the top lead frame.

3. The capacitor device of claim 1 wherein the first multilayer capacitor has a first and second dimension, wherein the first dimension is greater than the second dimension, and wherein first and second conductive end terminations electrically connected to the respective first and second electrode plates are oriented along the first dimension.

4. The capacitor device of claim 1 wherein the substrate is a circuit board.

5. The capacitor device of claim 1 wherein the top lead frame further comprises:
a top plate spaced apart from the bottom plate;
a first transition portion having a first end connected to the top plate and a second end, opposite the first end, adapted to be electrically connected to the substrate; and
a first flange portion, wherein the first flange portion is in electrical connection with the substrate, and
wherein the first flange portion is electrically connected to the second end of the first transition portion of the top lead frame.

6. The capacitor device of claim 5 wherein the first flange portion is soldered to the substrate.

7. The capacitor device of claim 5 wherein the first flange portion further comprises a hole.

8. The capacitor device of claim 7 wherein the first flange portion is mechanically and electrically connected to the substrate.

9. The capacitor device of claim 8 wherein the mechanical connection comprises:
a fastener, wherein the fastener is inserted through the hole in the first flange portion to connect the top lead frame to the substrate.

10. The capacitor device of claim 9 wherein the fastener is a screw.

11. The capacitor device of claim 9 wherein the fastener is a rivet.

12. The capacitor device of claim 5 further comprising:
a second transition portion having a first end connected to the top plate and a second end, opposite the first end, adapted to be electrically connected to the substrate.

13. The capacitor device of claim 12 further comprising:
a second flange portion, wherein the second flange portion is in electrical connection with the substrate, and
wherein the second flange portion is electrically connected to the second end of the second transition portion of the top lead frame.

14. The capacitor device of claim 12 wherein the second transition and second flange portions oppose the first transition and first flange portions.

15. The capacitor device of claim 12 further comprising:
a third transition portion having a first end connected to the top plate and a second end, opposite the first end, adapted to be electrically connected to the substrate.

16. The capacitor device of claim 15 further comprising:
a third flange portion, wherein the third flange portion is in electrical connection with the substrate, and
wherein the third flange portion is electrically connected to the second end of the third transition portion of the top lead frame.

17. The capacitor device of claim 15 further comprising:
a fourth transition portion having a first end connected to the top plate and a second end, opposite the first end, adapted to be electrically connected to the substrate.

18. The capacitor device of claim 17 further comprising:
a fourth flange portion, wherein the third flange portion is in electrical connection with the substrate, and
wherein the fourth flange portion is electrically connected to the second end of the fourth transition portion of the top lead frame.

19. The capacitor device of claim 1 wherein the top lead frame completely covers the first multilayer capacitor.

20. The capacitor device of claim 1 wherein the top lead frame comprises:
a top plate spaced apart from the bottom plate;
a first transition portion having a first end connected to the top plate and a second end, opposite the first end, adapted to be electrically connected to the substrate; and
a finger type connector, wherein the finger type connector is configured to be inserted into a hole in the substrate to form a mechanical and electrical connection, and
wherein the second end of the first transition portion is electrically connected to the finger type connector.

21. The capacitor device of claim 20 wherein the mechanical and electrical connection is a solder connection.

22. The capacitor device of claim 12 further comprising:
a first plurality of finger type connectors, wherein the second end of the first transition portion is electrically connected to the first plurality of finger type connectors; and
a second plurality of finger type connectors, wherein the second end of the second transition portion is electrically connected to the second plurality of finger type connectors.

23. The capacitor device of claim 22 wherein the second transition portion and second plurality of finger type connectors oppose the first transition portion and first plurality of finger type connectors.

24. The capacitor device of claim 1 wherein the bottom lead frame has a corrugated shape, and wherein the corrugated shape provides compliance between the first multilayer capacitor and the substrate.

25. The capacitor device of claim 1 wherein the electrical connections are soldered connections.

26. The capacitor device of claim 1 wherein the top and bottom lead frame are composed of copper, alloy 42, or kovar.

27. The capacitor device of claim 26 wherein the top and bottom lead frames are composed of the same material.

28. The capacitor device of claim 26 wherein the top and bottom lead frames are composed of different materials.

29. A capacitor device mountable on a plane of a substrate comprising:
an electrically conductive bottom plate adapted to be mounted substantially parallel to, and in electrical contact at the plane of the substrate;
a first multilayer capacitor comprising substantially parallel first and second electrode plates oriented substantially nonparallel to the bottom plate with the first electrode plates being electrically connected to the bottom plate; and
an electrically conductive top lead frame overlapping with, and electrically isolated from, the bottom plate, the top lead frame electrically connected to the second electrode plates and adapted to be electrically connected at the plane of the substrate.

30. An apparatus for connecting multilayer capacitors to a plane of a substrate, the multilayer capacitors having respective first end terminations and respective second end terminations, the apparatus comprising:
an electrically conductive bottom plate adapted to be mounted substantially parallel to the substrate, the bottom plate comprising a first side adapted to be in contact with, and electrically connected at the plane of the substrate, and the bottom plate further comprising an opposed second side adapted to be electrically connected to the respective first end terminations of the multilayer capacitors;
an electrically conductive top plate spaced apart from and overlapping the bottom plate adapted to be oriented substantially parallel to the substrate and further adapted to be connected to the respective second end terminations of the multilayer capacitors; and
an electrically conductive first transition portion having a first end connected to the top plate and a second end opposite the first end adapted to be electrically connected at the plane of the substrate.

31. The apparatus of claim 30 wherein the multilayer capacitors comprise first electrode plates electrically connected to the respective first end terminations and second electrode plates electrically connected to the respective second end terminations, the multilayer capacitors adapted to be mounted between the top plate and bottom plate such that the first electrode plates and the second electrode plates are substantially nonparallel to the substrate.

32. A PC board assembly comprising:
a PC board having a first conductor and a second conductor at the plane of the PC board; and
a capacitor device comprising:
an electrically conductive bottom plate adapted to be mounted substantially parallel to, and in electrical contact with the first conductor at the plane of the PC board;
a first multilayer capacitor comprising substantially parallel first and second electrode plates oriented substantially nonparallel to the bottom plate with the first electrode plates being electrically connected to the bottom plate; and
an electrically conductive top lead frame overlapping with, and electrically isolated from, the bottom plate, the top lead frame electrically connected to the second electrode plates and adapted to be electrically connected to the second conductor at the plane of the PC board.

33. The PC board assembly of claim 32 wherein the capacitor device further comprises:
a second multilayer capacitor juxtaposed to the first multilayer capacitor,
the second multilayer capacitor comprising substantially parallel first and second electrode plates oriented substantially nonparallel to the bottom plate with the first electrode plates being electrically connected to the bottom plate and the second electrode plates electrically connected to the top lead frame.

34. A PC board assembly comprising:
a PC board having a first conductor and a second conductor at a plane of the PC board; and
a capacitor device comprising:
a first multilayer capacitor comprising substantially parallel first and second electrode plates oriented substantially nonparallel to the PC board with the first electrode plates being electrically connected to the first conductor at the plane of the of the PC board; and
an electrically conductive top lead frame overlapping with, and electrically isolated from, the first conductor, the top lead frame electrically connected to the second electrode plates and adapted to be electrically connected to the second conductor at the plane of the PC board.
